(19) United States
(12) Patent Application Publication
(10) Pub. No.: US 2004/0150121 A1
(43) Pub. Date: Aug. 5, 2004

(54) Gas entrainer

(76) Inventor: Richard James Armstrong, Toronto (CA)

Correspondence Address: Richard James Armstrong, 7 Jackes Ave. Apt. 703, Toronto, ON, M4T 1E3, CA

(21) Appl. No.: 10/357,550

(22) Filed: Feb. 5, 2003

(51) Int. Cl. B01F 3/04

(52) U.S. Cl. 261/91; 261/93

(57) ABSTRACT

The gas entrainer is a rotodynamic machine for trapping and dispersing bubbles of air into a pool of water. A flat circular disc is mounted for rotation close to and concentric with one end of an open cylindrical tube of equal diameter to form an annular nozzle therebetween. Upon the disc and tube end being immersed in water, the spinning disc draws air down the tube and out through the nozzle to disperse it as fine bubbles into the pool. The faster the disc is spun, the more air bubbles are produced; and this at a considerable depth of water. The disc or rotor employed is without blades or paddles and accomplishes entrainment simply by viscous friction between the disc and water in combination with the closely spaced tube end.

### FIELD OF THE INVENTION

This invention relates to devices for entraining air with water where the water is the continuous phase and the air is in the form of bubbles mixed with the water. The terms air and water are herein employed since these are most commonly employed but my invention contemplates other combinations of gas and liquid.

### BACKGROUND

It is sometimes desirable to mix air with water to effect some chemical reaction or to exchange some chemical between the phases and entraining the air by the water is often resorted to. Prior types of entrainers are commonly called ejectors or eductors. In these devices a jet of water under pressure is directed down a tube in communication with the atmosphere and air is thereby sucked in or entrained by the water jet.

Other devices for mixing air with water are called aerators where some form of motor driven stirring paddle or bladed rotor is provided which more or less entrains air bubbles by violent agitation of the water surface, the bubbles being driven into the surrounding water by currents generated by the rotor. These prior types are termed surface aerators since they are limited to aeration within the surface region of a pool of water, not being operable to any appreciable depth unless provided with additional means for pumping air to the submerged rotor.

Another type for operation at some depth, often referred to as a gas liquid contacter, has one or more bladed rotors installed on a shaft immersed in a tank of liquid. Air or other gas is introduced immediately below the rotor by means of a sparger supplied with compressed air or gas, often simply a pipe with drilled holes. The rotor breaks up the bubbles from the sparger and distributes them into the tank.

All of these prior pieces of equipment operate to entrain the air but the precise nature of entrainment has heretofore been imperfectly understood. I have discovered what I consider to be the true nature of air entrainment.

### THE PRINCIPLE OF AIR ENTRAINMENT

When a jet of water strikes a still pool of water, a dimple is formed about the interface of the jet with the pool water. If the velocity of the jet is small, the formation of this dimple is the only manifestation. However, if the jet is moving fast enough, air bubbles are seen to follow the jet into the pool. This is a common phenomenon and is easily observed whenever a stream of water, such as that emerging from an ordinary sink faucet, flows into a basin of still water.

The explanation of this phenomenon is the jet of water, by viscous shear, drags the pool surface down forming a dimple and surrounding air flows into this dimple so formed. The faster the jet is flowing the deeper is the dimple formed. However, the dimple becomes unstable upon reaching a critical length and collapses, trapping the enclosed air in the form of a bubble which is swept away by the combined flow of the jet and the pool water immediately adjacent. The formation and collapse of the dimple is cyclic, thus forming a string of air bubbles, or entraining the air. A faster moving jet produces an increased quantity of air bubbles. Furthermore, the dimple is unstable in its circumferential length about the jet and does not collapse uniformly but breaks up into many segments which is the cause of the many small bubbles observed.

Simply stated, when a fast moving stream of water encounters substantially still water at an air interface, it forms an unstable dimple, which upon collapsing entraps air which is swept away by the jet. This is the principle of air entrainment which I have discovered and I apply it to my invention of a new type of gas entrainer as herein described.

### OBJECTS OF THE INVENTION

Employing this new principle, a gas entrainer that I describe can be constructed that produces a large swarm of air bubbles and is simple in operation. Furthermore, my entrainer can be operated at a considerable depth below the water surface to suit a particular application without the need of a separate air pump.

### THE INVENTION

I have found that by locating a flat, plane faced circular disc close to and concentric with one end of an open cylindrical tube of equal diameter to form a thin annular nozzle therebetween then immersing the disc and tube end in a pool of water and spinning the disc, the device draws air down the tube and out through the nozzle to disperse it as fine bubbles into the pool. The faster the disc is spun, the more air bubbles are produced; and this at a considerable depth of water. The disc or rotor I employ is without blades or paddles and accomplishes entrainment simply by viscous friction between the disc and water in combination with the closely spaced tube end.

### IN THE DRAWINGS

FIG. 1 is a diametrical sectional view of a schematic representation of the principle of operation of my entrainer;

FIG. 2 is a view on the underside of the aerator of FIG. 1;

FIG. 3 is a diametrical section of a preferred embodiment of my invention applied to an aerator;

FIG. 4 is a view on the underside of the embodiment shown in FIG. 3;

FIG. 5 is an enlarged scrap section of the disc and shroud employed in the embodiment shown in FIG. 3;

FIG. 6 is a part sectional view of one form of an aerator according to my invention installed in a deep tank of water; and,

FIG. 7 is a section along the line 7-7 in FIG. 6.

### ESSENTIAL FEATURES AND OPERATION OF THE INVENTION

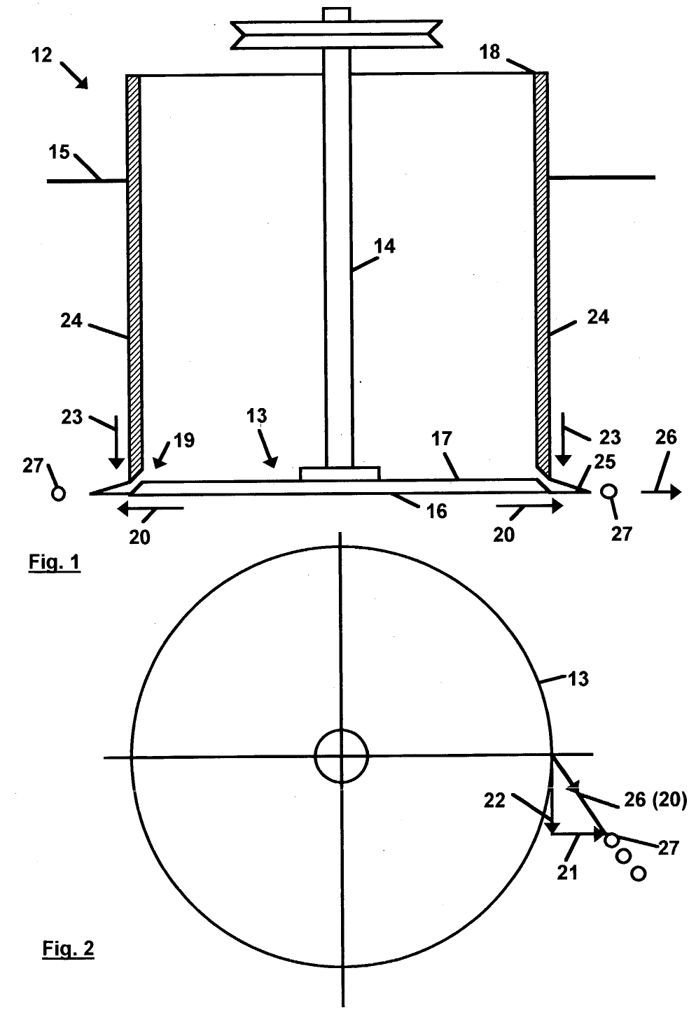

With reference to FIG. 1 and FIG. 2 my entrainer 12 is shown in schematic form and comprises a circular disc as at 13 supported at the symmetrical axis of rotation by a shaft 14 and immersed in water to a predetermined depth below water surface 15. Disc 13 has a flat water face 16 normal to the axis of rotation and an obverse air face 17. Water face 16 must be a flat, plane surface normal to the axis of rotation of disc 13 since this is important to the operation of entrainer 12. However, air face 17 need not necessarily be a flat plane. A circular shroud 18, having an outer diameter substantially equal to that of disc 13 is spaced a predetermined distance away from air face 17 to form an annular nozzle 19 about the periphery of disc 13. Shroud 18 is of sufficient axial length to reach from nozzle 19 to above the water surface 15. The outer rim of disc 13 and the lower end of shroud 18 preferably have bevelled edges to enable close spacing and to allow free passage of air into nozzle 19.

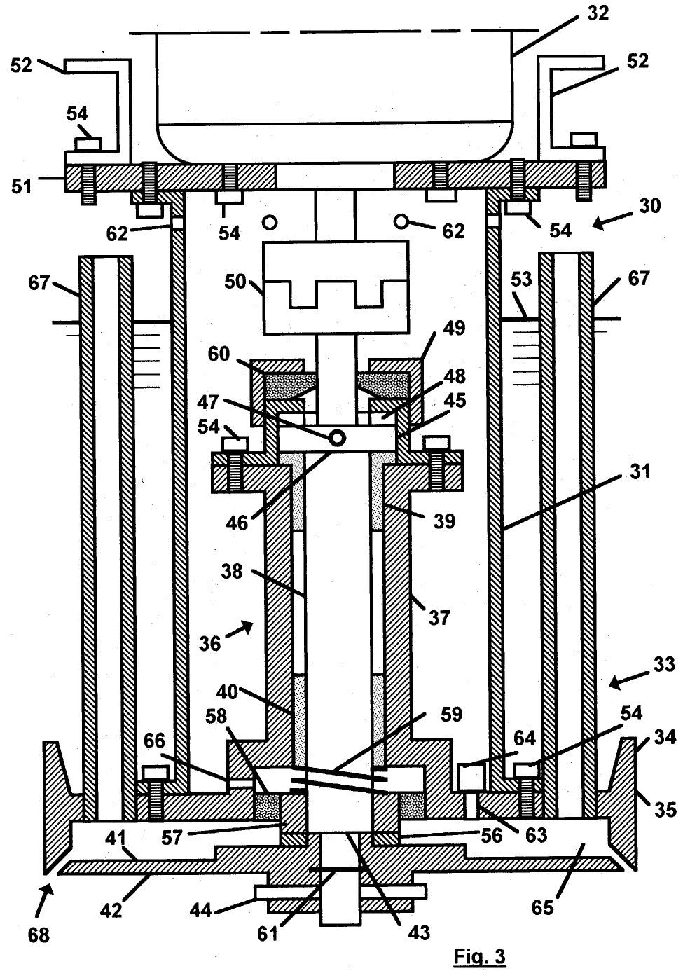

It will be understood that entrainer 12 is shown in schematic and details necessary for the operation of an actual entrainer such as shaft bearings, supporting structure and specific drive means have been omitted for the purpose of clear illustration of the essential features of my entrainer. Such details are described more fully with reference to FIG. 3.

Upon disc 13 being rotated, viscous shear or friction between disc 13 and the water sets up a primary water flow 20 coming off the water face 16 which has a radial component 21 and a circumferential component 22. The primary flow 20 coming off water face 16 induces a secondary axial flow 23 to come off the exterior wall 24 of shroud 18. Secondary flow 23 initially has an axial component only along wall 24 and is thus not flowing in the same direction as primary flow 20 but at right angles thereto. The axial flow 23, having little or no circumferential component of flow, acts similarly to still water into which primary flow 20 is entering and with air within shroud 18 a dimple 25 containing air is formed at the interface. As secondary flow 23 approaches very close to primary flow 20, similar radial and circumferential components are imparted to it by viscous shear until the two are combined into one combined or mixed flow 26 at the interface therebetween, following the path of flow 20 coming off disc 13 as shown in FIG. 2. The drawings show a single line of water flow coming off disc 13 and wall 24 but of course the flow occurs about the entire periphery of disc 13 and wall 24, forming a circular sheet of fast moving water and air bubbles 27 streaming from the spinning disc 13. The rate of bubble formation is directly related to the rate of generation of dimple surface which is simply the radial component 21 of the velocity of mixed flow 26 times the periphery of disc 13.

Upon startup and with the entrainer 12 immersed in water, the interior of shroud 18 would be filled with water but friction between upper air surface 17 and the water together with the combined flows 20 and 23 draw the water out through nozzle 19 until just air is within shroud 18 and dimple 25 is formed.

In operation, with disc 13 spinning fast enough to produce a fast moving flow 20, dimple 25 is unstable and collapses, trapping the contained air in the form of bubbles 27 which are swept away by combined flow 26. In other words, the dimple formed by the fast moving water into relatively still water collapses and traps the contained air as a bubble which is swept away after which the dimple reforms. The rate of bubble collapse, or frequency, is dependent upon the velocity of radial component 21 which in turn depends upon the rotational speed of disc 13. The faster disc 13 is spinning, the higher is the frequency of bubble collapse and the greater is the quantity of bubbles 27 produced. Also the formation and collapse of dimple 25 is not uniform about nozzle 19, dimple 25 being unstable circumferentially as well. Thus although the fragmented formation and collapse of dimple 25 would occur at the same frequency, the phenomenon is not generally in phase about the disc 13 and many small bubbles are thereby formed. The combined flow 26 distributes the bubbles into the pool of water at whatever depth aerator 13 is operating. It is preferable to have the wall 24 of shroud 18 perpendicular to the water face 16 of disc 13 so that flow 23 has an axial component only and acts as relatively still water into which primary flow 20 enters, for it is the difference of radial flow that results in good bubble formation.

While a disc 13 and shroud outer wall 24 having equal diameters will operate to form a dimple to produce air bubbles, the diameter of outer wall 24 is preferably somewhat larger than the outer diameter of disc 13 so that primary flow 20, leaving disc 13, meets induced flow 23 after it has left wall 24. This ensures the formation of the condition of a fast moving stream of water encountering relatively still water which is a necessary condition to form dimple 25 and to produce air bubbles 27. Further discussion of this requirement is given later with reference to FIG. 5.

Wall 24 immediately before nozzle 19 should preferably have an axial length sufficient to definitely establish flow 23. This length is preferably equal to at least one-third of the radius of disc 13. This provides a uniform axial flow coming off wall 24 to meet the uniform flow 20 from disc 13 to maintain good formation of dimple 25. An entrainer according to my invention can be constructed with simply a spinning disc adjacent to a shroud which forms an annular nozzle about the disc and with some means to exclude water from and to feed air into the nozzle. However, the cylindrical wall 24 immediately before nozzle 19 aids in the formation of air bubbles 27 as explained above.

The radial component 21 of primary flow 20 and the corresponding induced radial component of secondary flow 23, which are mixed and thus equal in direction and magnitude, are responsible for the formation of the dimple 25 and these radial components must have sufficient velocity head to overcome the head due to depth of submergence plus that required to form and carry away the air bubbles 27. Furthermore, all the radial flow energy initially comes from the primary radial component 21 of the primary flow 20 as generated by the rotating disc 13. Thus the rate of air bubble formation is determined by the peripheral speed of disc 13 as it exceeds the minimum required to overcome the head of submergence.

With reference to FIG. 2 the primary water flow 20 leaves disc 13 at an angle of approximately 30 to 40 degrees to the circumferential direction 22, for water at ambient temperature. This angle remains fairly constant over a wide range of disc sizes and speeds and is the result of viscous shear in the water. The radial component 21 is responsible for forming and carrying away the air bubbles and it is this radial flow which induces the radial component of the induced flow 23. Now since the air bubbles 27 are carried away by the combined flow 26, and since flow 26 is composed of flows 20 and 23 flowing together, these two flows, for the purpose of calculation, can be assumed equal in mass flow rate immediately about the bubbles 27. The total mass rate of flows 20 and 23 may differ but the combined portions flowing along with the air bubble, since they are flowing at the same speed and are jointly responsible for the formation of the air bubble, can be assumed equal in mass rate. Also at dimple 25 it is the thin surface layers only of flows 20 and 23 which are involved in the trapping of air bubbles 27 and it is in these thin layers that the momentum exchange of importance takes place, flow 20 sharing momentum with flow 23.

This leads to the following analysis.

Let

Primary radial mass flow rate=Mp lbs/sec

Radial velocity of flow Mp=Vp ft/sec

Secondary radial mass flow rate=Mi lbs/sec

Combined radial velocity=Vc ft/sec

Depth of submergence=h ft

Gravitational constant=g=32.17 feet/sec/sec

Peripheral rim velocity of disc 13=PS ft/sec

Flow angle leaving disc=35 degrees

Then for momentum exchange in the thin surface layers,

Mp×Vp=(Mp+Mi)×Vc

but,

Mi=Mp

therefor,

Vp=2×Vc

The combined radial flow must maintain the continuous formation of dimple 25 against the pressure head at depth and in order to overcome this head due to the depth of submergence of nozzle 19, the minimum velocity required for the combined radial flow is,

Vc min=sqr(2gh)

thus,

Vp min=2×sqr(2gh)

now,

Vp/PS=tan 35

therefor,

PS min=2×sqr(2gh)/tan 35

From which can be obtained the minimum rotational speed of the disc to overcome the head of submergence.

The foregoing neglects any flow energy losses that may incur which can be considerable. To overcome flow losses and to generate a large flow of air bubbles it is preferable to operate the disc at a rotational speed considerably in excess of the minimum value obtained by the foregoing analysis. I commonly employ a rotational speed 50% higher than that calculated by the method given here but larger increases are also possible.

As an example, consider a disc of 1.5 feet diameter and submerged to a depth of fifteen feet and using 35 degrees as the angle at which the flow 20 leaves the disc.

Now,

PSmin=2×sqr(2×32.17×15)/tan 35=88.73 feet/sec,

and the minimum rotational speed of the disc is then PS×60/(Π×1.5)=1,130 rpm.

Upon the disc 13 spinning faster than this minimum, the dimple 25 will be established and air bubbles 27 will begin to form. As the disc rotational speed is increased beyond that required to establish dimple 25, the rate of bubble formation will increase. A useful range in this case would be to operate disc 13 at about 50% higher than this minimum. The disc in the above example operated at 1,700 rpm at a depth of fifteen feet would produce a very large swarm of air bubbles. In this case a standard 1725 rpm motor may be employed with direct drive. Disc 13 may have any diameter consistent with the intended use, the speed of operation being obtained as above. It should be noted that disc diameters less than about one-third foot result in very high rotational speeds if it is intended to operate at a considerable depth of water.

There is a minimum velocity required for flow 20 to produce air bubbles and this can be estimated by employing no less than five feet as a depth of submergence in the above calculation. Even though it may be intended to operate close to the water surface at no great depth, this minimum of five feet should still be employed and together with the provision that in order to produce a useful flow of air bubbles, the disc should be operated at least 50 percent higher than that calculated.

From the foregoing it will be apparent that my entrainer in its simplest form comprises a rotatably driven circular disc, an annular nozzle located adjacent to the disc, and means for excluding water from and admitting air to the nozzle upon the entrainer being immersed in water and the disc rotated. Simply, if a disc is rotated in water and an annular nozzle admits air about the periphery of the disc, the spinning disc will disperse the air as bubbles into the water. However, the use of shroud 18 having a wall 24 greatly enhances the performance of my entrainer.

### DETAILED DESCRIPTION OF THE PREFERRED EMBODIMENT OF THE INVENTION

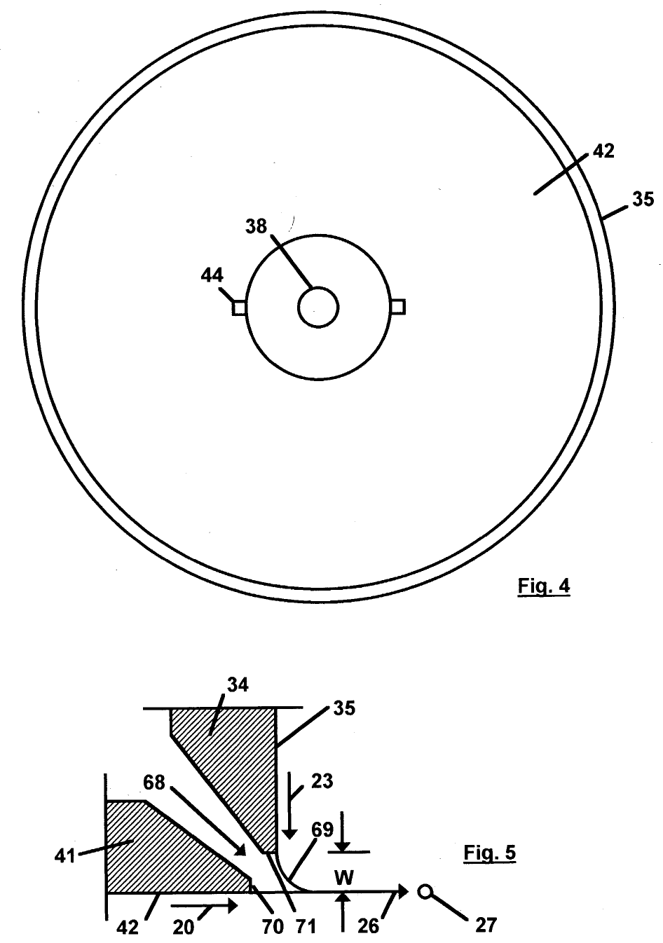

With reference to FIG. 3 and FIG. 4 the best form of application of my entrainer which I contemplate is a pool aerator indicated generally as 30 and comprises a main housing 31 supporting a motor drive 32 at its top or above water surface end and an aerator assembly indicted as 33 at its lower or submerged end. Aerator assembly 33 comprises a shroud 34 having a cylindrical wall 35 extending axially a predetermined distance. Shroud 34 serves as a lower attachment for a shaft assembly indicated as 36 which comprises bearing housing 37, which in this case is cast as an extension to shroud 34, and a drive shaft 38 mounted on an upper bearing 39 and a lower bearing 40. A circular disc 41 having a flat water face 42 is mounted on the lower end of shaft 38 and is held spaced a predetermined distance from shroud 34 by abutment on a shoulder 43 on shaft 38. The face 42 of disc 41 should be smooth and without blades or vanes. Even with a smooth surface 42, disc 41 exerts considerable torque on shaft 38 when aerator 30 is operating and it is preferable to securely lock disc 41 to shaft 38 by means of a split pin 44. The boss for the pin is preferably not be larger in diameter than about one-quarter of the diameter of disc 41. Also there is a substantial upwardly directed end load on shaft 38 caused by a difference in pressure acting on face 42 of disc 41 when aerator is operating a depth and this load is supported by a collar 45 abutting a second shoulder 46 on shaft 38 and locked to shaft 38 by set screw 47. Collar 45 is supported on a thrust bearing 48 which may be of the needle roller type and which is secured to bearing housing 37 by a cap 49. Connection between motor 32 and shaft 38 is effected by a flexible coupling 50. If the disc speed as calculated does not fall close to the shaft speed of a standard motor it will be necessary to employ a belt drive between the motor and shaft 38, or some other means of adjusting the speed, to arrive at the desired disc rotational speed. The assembly, disc 41, shaft 38, collar 45, and coupling 50 should be dynamically balanced for smooth high speed running of aerator 30.

Motor 32 is mounted on a motor plate 51 which is secured to the upper end of housing 31. Mounting beams 52 support aerator 30 with motor 32 above the pool water surface 53 by extension to the sides (not shown) of the water pool. Mounting beams 52 must be well secured to the tank sides to absorb the torque reaction of disc 41 rotating in the pool water. Motor plate 51, housing 31, and shroud 34 may be fastened together by convenient means such as screws 54. It is preferable to seal all joints such as by the use of form in place gasket material but especially the joint between bearing housing 37 and cap 49 to prevent seepage of water past this joint.

The shaft assembly 36 is temporarily submerged in water at times during normal operation of aerator 30 and the bearings must be protected. Bearing 40 is protected by a face type of seal which comprises a rotating ring 56 secured to disc 41 and a fixed ring 57 flexibly secured to bearing housing 37 by a rubber sealing ring 58. Spring 59 urges ring 57 into rubbing contact with ring 56 forming the seal. Material for rings 56 and 57 should be selected for the expected operating conditions. It should be noted that seal 55 would ordinarily be operating dry, being only occasionally immersed in water when the aerator is shut off. Disc 41 is sealed on shaft 38 by an O-ring seal 61. Since the upper end of bearing housing is not intended to be immersed in pool water at any time, bearings 39 and 48 can be protected by a conventional lip type of seal 60.

During normal operation with housing 31 containing air some water seepage into housing 31 could occur and to prevent accumulation vent holes 62 above water surface 53 are provided in main housing 31 and a drain hole 63, connected through a check valve 64, is provided in shroud 34. The pressure in air space 65 between shroud 34 and disc 41 will normally be somewhat below atmospheric while the pressure within housing 31 will be atmospheric. This difference in pressure will suck out any water through check valve 64 and out through drain hole 63. A slight bleed of air through holes 62 and hole 63 will always be present during operation of aerator 30 in the absence of any water within housing 31 but this amount can be made very small by suitable sizing of hole 63. Some water seepage is possible past seal faces 56 and 57 and a drain 66 is provided to allow this seepage to drain away into housing 31 and thence out through check valve 64 before it can reach bearing 40.

Outside air is supplied to air space 65 by one or more stand pipes 67 threaded into or otherwise operably secured to shroud 34 and which reach above water surface 53. The number of stand pipes 67 employed will depend upon a particular design but the total air passage area afforded by pipes 67 is preferably at least as large as nozzle 68 area.

Disc 41 is spaced a predetermined distance from shroud 34 to form an annular nozzle 68 therebetween. Due to the small scale of the drawing the spacing between shroud 34 and disc 41 in FIG. 3 is exaggerated for clarity of construction.

With reference to FIG. 5 details of annular nozzle 68 are illustrated. In this discussion the flow patterns as illustrated in FIGS. 1 and 2 are applicable. The formation of dimple 69 is a natural phenomenon and has a natural range of size up to a maximum of about 0.1 inches for water at ambient conditions. The nozzle width, indicated as W on the drawing should not be larger than this natural range and is preferably much less. The width W of nozzle 68 is preferably from 0.02 to 0.06 inches wide. Shroud wall 35, which has an axial length of at least one-third of the radius of disc 41, should preferably project radially beyond disc 41 a distance about equal to one-half the nozzle width W. Secondary flow 23 coming off wall 35 is subjected to a pressure force acting radially inwardly which is due to the depth of submergence. This tends to force flow 23 back towards the rim of disc 41. However, in order for a dimple to form, flow 23 must strike flow 20 coming off disc 41 and not the disc itself. That is, water must flow into water to form a dimple to entrain air. The shroud wall 35 being proud of disc 41 ensures the water flows will meet. This is but a fine improvement and the aerator will operate satisfactorily with disc 41 and wall 35 having the same diameter.

Disc 41 and wall 35 are tapered within to allow free passage of air to a dimple 69 and this requires fairly thin edges in order to be consistent with the width of nozzle 68. The width of outer edge 70 of disc 41 and the width of lower end 71 of wall 35 should be minimal within good design practice and are preferably not greater than nozzle width W. Disc 41 is preferably made from metal to withstand centrifugal stress without distortion as it is spun at high speed. The under surface 42 should preferably have a smooth finish since this produces an adequate supply of bubbles without absorbing too much power. I have found a commercial fine machined finish for surface 42 to be satisfactory.

### USE OF THE INVENTION

The flat disc 13 or 41 that I employ to generate the primary water flow in my entrainer is without blades and thus differs from the rotors employed in the prior art and will use less power that prior types of equivalent size operating at the same rotational speed. An estimation of the power required to operate the entrainer according to my invention can be obtained by employing the following computer program written in QBASIC. This program gives an answer on the high side to ensure the motor for driving the disc will be large enough.

REM WETDISCP.BAS
REM Ref Boundary-Layer Theory, H. Schlichting, McGraw-Hill
REM 6th ed 1968 pp 606 - 608
DEF fntad (X) = TAN(Pi * X / 180)
REM CONSTANTS
Pi = 3.141593
g = 32.17
REM Rd is the radius of the disc, ft
REM V is the kinematic viscosity of the liquid
REM RPM is the rotating speed of the disc
REM de is the density of the liquid lbm/cu ft
REM M is the torque on the disc, lb ft
REM A is the observed discharge angle from the disc
REM USER INPUTS
Trial$ = “PATENT EXAMPLE TRIAL 1”
RD = .75
V = 1.4 * 10 \hat{ } −5
RPM = 1700
de = 62.4 / g
A = 35
REM END OF USER INPUTS
REM w is the angular velocity of the disc, rad/sec
REM Re is the Reynolds number
REM Cm is the moment coefficient
REM M is the torque on the disc, for one side
REM D is the boundary layer thickness at radius R
REM Q is the water volume flow into the disc
REM VP is the viscous shear horsepower
REM PV is the disc peripheral velocity
REM RV is the water flow radial velocity leaving the disc
REM Rc is the combined radial water velocity after the nozzle
REM AR is the rate of surface generation at disc rim
w = 2 * Pi * RPM / 60
Re = w * (RD \hat{ } 2) / V
Cm = .146 * (Re \hat{ } −.2)
M = (.073 * de * (w \hat{ } 2) * (RD \hat{ } 5) * ((V / w) * RD \hat{ } 2) \hat{ } .2) / 2
D = .526 * RD * ((V / RD \hat{ } 2) * w) \hat{ } .2
Q = .219 * RD \hat{ } 3 * w * Re \hat{ } −.2
VP = RPM * M * 12 / 63025
PV = 2 * RD * Pi * RPM / 60
RV = PV * fntad(A)
Rc = RV / 2
AR = Rc * 2 * RD * Pi
REM OUTPUT
LPRINT , “WETDISCP.BAS”, DATE$, TIME$
LPRINT , “Trial number ”; Trial$
LPRINT , “USER INPUTS”
LPRINT , “Disc radius =”; RD; “ ft”
LPRINT , “Fluid kinematic viscosity =”; V; “ sq ft/sec”
LPRINT , “RPM =”; RPM
LPRINT , “Fluid density =”; de; “ poundals/cu ft”
LPRINT , “Observed disc discharge angle =”; A; “ degrees”
LPRINT , , “OUTPUT”
LPRINT , “WATER FLOW CONDITIONS”
LPRINT , “Angular velocity =”; w; “ radians/sec”
LPRINT , “Reynolds number =”; Re
LPRINT , “Moment coefficient =”; Cm
LPRINT , “Torque on disc =”; M * 12; “ lb in”
LPRINT , “Boundary layer thickness at radius Rd =”; D * 12; “ in”
LPRINT , “Volume flow into disc =”; Q * 60; “ cu ft / min”
LPRINT , “Mass flow into disc =”; Q * 60 * 62.4; “ lbs / min”
LPRINT , “US gallons pumping rate =”; Q * 60 * 7.489; “ gpm”
LPRINT , “Viscous shear horsepower =”; VP
LPRINT , “Disc peripheral velocity =”; PV; “ ft/sec”
LPRINT , “Water radial velocity =”; RV; “ ft/sec”
LPRINT , “Combined radial velocity =”; Rc; “ ft/sec”
LPRINT , “Rate of surface generation =”; AR; “ sq ft/sec”
END

Employing this program to calculate the power required for the foregoing example, with the inputs given in the USER INPUTS section, gives the following results.

Torque on disc=216 lb in

Pumping rate=314 gpm

Power=5.83 hp

Surface generation=220 sq ft/sec

The surface generation rate calculated by the program is that coming radially off the disc. Air is sandwiched between this water surface and that water surface coming off the wall 24 in the form of a sheet broken up into air bubbles and travelling outwardly at the rate of the combined radial component which is given as Rc in the immediately foregoing program. The rate of bubble sheet formation is thus equal to the value given for surface generation in the program. It can be seen that with over 200 square feet of bubble sheet being generated every second the rate of bubble formation in this example is very high.

Power is required both to pump the pool water by the disc 41 and to pump air through the nozzle 68 at the depth of submergence and this is supplied by motor 32. The required power given in the program is the calculated value required to drive disc 41 only, but being based on the recommended 50% increase in disc speed over the minimum previously calculated, it may also be taken to include the relatively small amount of power required to pump the air.

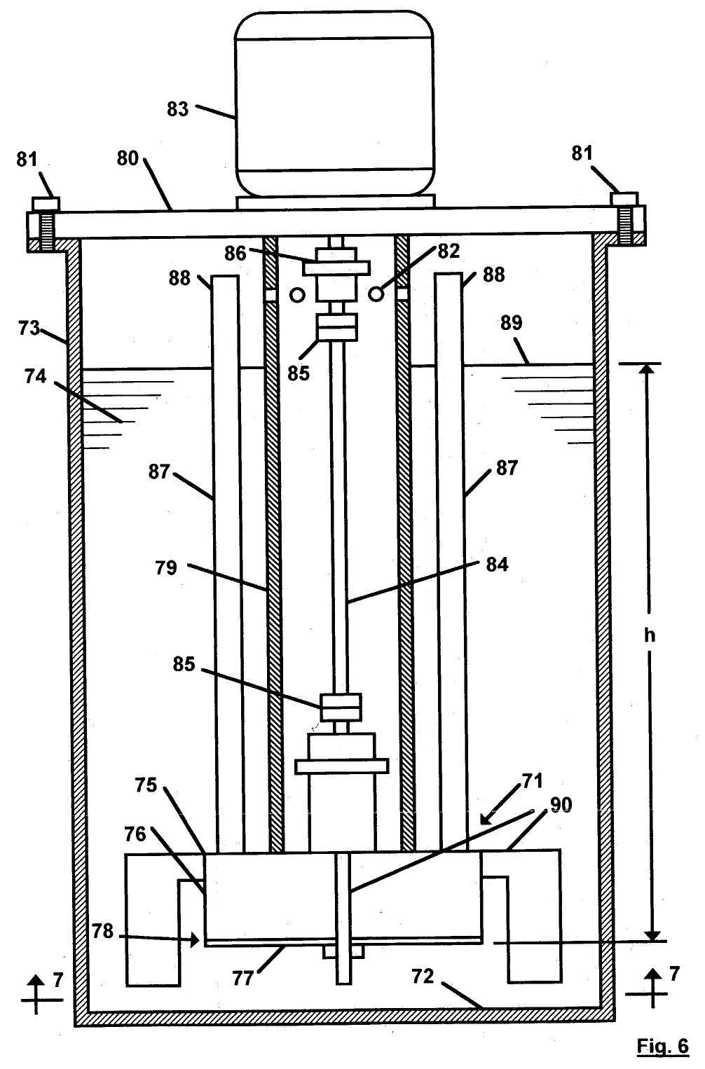

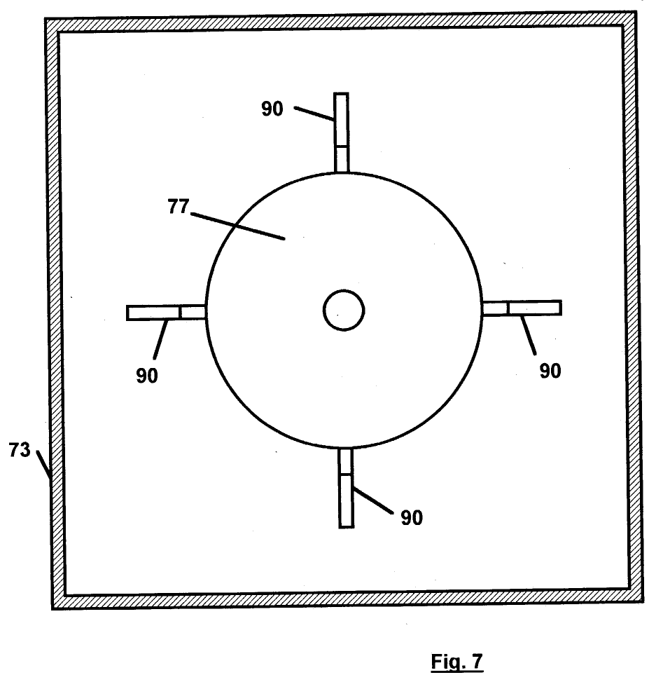

With reference to FIG. 6 and FIG. 7 one application of my invention as applied to an aerator is illustrated where my entrainer indicted as 71 is installed near the bottom 72 of a tank 73 containing the liquid 74 to be aerated. Entrainer 71 is similar in construction and operation to that employed in aerator 33 shown in FIG. 3 and has a cylindrical shroud 75 with an axial wall 76 fixed closely adjacent to a flat disc 77 forming an annular nozzle 78 therebetween. Entrainer 71 is supported by the lower end of tubular housing 79 which in turn is fixed by cross beam 80 to the sides of tank 73 by bolts 81. Housing 79 is provided with air bleed holes 82 for the purpose as described for holes 62 in FIG. 3.

The disc 77 of entrainer 71 is rotationally driven by motor 83 through a drive shaft 84. Drive connections between motor 83 and shaft 84, and between entrainer 71 and shaft 84 is by a universal joints 85. This arrangement takes up the slight misalignment between motor 83 and entrainer 71 likely to be present when the housing 79 is of any great length. The assembly consisting of beam 80, housing 79, and entrainer 71 should be stiff enough to absorb the torque generated by spinning disc 77 as given in the foregoing program.

Before start-up of entrainer 71, water would normally occupy the interior of housing 79 and on start-up disc 77 would be pumping water from housing 79 and this will put a temporary additional load on motor 83. A friction clutch 86 installed at the motor end of shaft 84 can be employed to limit the torque on motor 83 during start-up of entrainer 71. This same clutch 86 can also modify the start-up torque due to the moment of inertia of disc 77.

Outside air is supplied to shroud 75 and thence to nozzle 78 by one or more air pipes 87 having the upper ends 88 extending above liquid surface 89. The depth of submergence or the pressure head is indicted as h on the drawing and is that depth from the liquid surface to the underside of disc 77. This is the head through which outside air must be pumped to the nozzle 78.

In operation the spinning disc 77 generates air bubbles and drives them into liquid 74 at whatever depth it is operating. Disc 77 also generates a considerable flow of liquid and this distributes the air bubbles throughout tank 73. Disc 77 sets up a swirling motion in liquid 74 and in a case where the swirl is not desirable, spoiler vanes 90 may be secured to shroud 75, such as by welding, to remove the circumferential component of flow coming from disc 77. The inner edge of vanes 90 should be spaced at least ten nozzle widths from shroud wall 76 so as not to interfere with the formation of the dimple. It should also be noted that use of vanes 90 will considerably reduce the torque reaction on housing 79 and thus the beam 80.

From the foregoing in can be seen that the aerator I have described, employing a newly discovered principle, is simple in operation and will produce a large swarm of air bubbles at a considerable depth below the water surface without the need for a separate compressed air supply.

I claim:

1. An entrainer comprising:
a disc having a flat circular face and a symmetrical axis of rotation normal to said face;
an annular nozzle adjacent the obverse face of said disc; and,
means for excluding water from and communicating air to said nozzle upon said entrainer being immersed in water and said disc rotated about said axis.

2. An entrainer comprising:
a circular disc having a flat face and a symmetrical axis of rotation normal to said flat face;
a circular shroud having an open end supported concentric with and spaced from the obverse face of said disc to form an annular nozzle therebetween;
motor means for driving said disc about said axis; and,
means for excluding water from and communicating air to said shroud and thence said nozzle upon said entrainer being immersed in water and said disc rotated by said motor means.

3. The entrainer as claimed in claim two wherein said shroud open end includes a cylindrical wall perpendicular to said disc.

4. The entrainer as claimed in claim three wherein said shroud wall has an axial length of at least one-third of the radius of said disc.

5. The entrainer as claimed in claims three or four wherein the outside diameter of said shroud wall is larger than the diameter of said disc by an amount equal to the width of said nozzle.

6. An entrainer comprising:
a circular disc having a symmetrical axis of rotation;
a flat face on one side of said disc normal to said axis;
a circular shroud having an open end supported concentric with and spaced a predetermined distance from the obverse side of said disc to form an annular nozzle therebetween;
motor means for driving said disc about said axis at a predetermined rotational speed; and,
means for excluding water from and communicating air to said shroud and thence said nozzle upon said entrainer being immersed in water to a predetermined depth and said disc rotated by said motor means.

7. The entainer as claimed in claim six wherein said shroud open end includes a cylindrical wall perpendicular to said disc.

8. The entrainer as claimed in claim seven wherein said shroud wall has an axial length of at least one-third of the radius of said disc.

9. The entrainer as claimed in claims seven or eight wherein the outside diameter of said shroud wall is larger than the diameter of said disc by an amount equal to the width of said nozzle.
